(19) United States
(12) Patent Application Publication
(10) Pub. No.: US 2002/0117528 A1
(43) Pub. Date: Aug. 29, 2002

(54) Lottery ticket dispenser transport mechanism

(75) Inventor: Edmund F. Turek, Cincinnati, OH (US)

Correspondence Address: Wood Herron & Evans LLP, 2700 Carew Tower, Cincinnati, OH, 45202, US

(73) Assignee: Interlott Technologies, Inc.

(21) Appl. No.: 09/521,520

(22) Filed: Mar. 8, 2000

(51) Int. Cl. B26F 3/00

(52) U.S. Cl. 225/4; 225/100

(57) ABSTRACT

An improved arrangement for a lottery ticket or other article dispenser system includes a direct drive coupled to a drive mechanism such as a motor and feed and discharge rollers. The feed and discharge rollers transport a stream of articles such as lottery tickets which are serially joined together along lines of weakness such as perforations or the like. Coupling the feed and discharge rollers to the common drive mechanism reduces and minimizes the need for calibration and setup for the operation of the dispenser system. Additional features of the invention include a rack and spur gear arrangement for movement of the burster wheel across the path of the tickets and platens arranged and configured in the burster system to improve the bursting quality and operation.

### BACKGROUND OF THE INVENTION

This invention relates generally to article dispensing systems and more particularly to an improved system and method for dispensing lottery tickets.

State sponsored lotteries are now a popular and accepted method of generating revenue and providing entertainment. One popular form of lottery uses an instant lottery ticket on which winning or non-winning combinations are pre-printed before distribution and the player knows immediately after purchasing the ticket whether or not it is a winning ticket. A common system for distributing instant lottery tickets includes a large number of ticket dispensing machines located at drug stores, supermarkets, convenience stores and the like. Common concerns associated with such lottery ticket dispensing machines are the speed with which they dispense the tickets, the security or anti-theft characteristics of the dispenser and the ability to accurately provide an accounting for the tickets sold from each machine.

Due to the popularity of the instant lottery ticket games and the advantage of minimizing clerical involvement with the purchasing and dispensing of instant lottery tickets, it is common for a large number of tickets to be stored within the dispensing machine. Presently, tickets are commonly stored in a fanfold form so that they may be rapidly fed out from a storage compartment without the risk of unintentionally dispensing too many tickets as is common when individual tickets are stored and dispensed from the machine. However, the fanfold tickets must be separated by the machine prior to being dispensed. The mechanism to separate the fanfold tickets from one another should ensure that the separation of the tickets occurs only at the joinder line between the tickets despite whatever variations in the size of tickets and slippage or inaccuracy in the dispensing mechanism may be present.

A problem associated with the dispensing of lottery tickets stored in a fanfold stream is how to ensure that each ticket as it becomes the leading ticket will be separated from the next following ticket precisely along the joinder line between the tickets. In such a fanfold stream, a line of weakness such as a perforation line is provided to define each ticket and to permit fanfolding of the stream of connected tickets. Commonly, each fold contains a single ticket but in alternative embodiments, a number of tickets for example five or more may be provided within each fold. Lottery tickets conventionally are constructed from laminated layers of paper or cardboard and as such are relatively stiff and inflexible.

Prior art solutions to these problems include using a knife edge or cutting blade to slice through the stream of tickets. This is not desirable because the knife edge may cut through the tickets at any point such as in the middle of the ticket. Therefore, a highly precise alignment device usually must be provided with a knife edge to bring it into precise alignment with the joinder line between the tickets.

Successful prior art solutions to these problems are disclosed in U.S. Pat. Nos. 4,982,337 (“the '337 patent”) and 5,836,498 (“the '498 patent”), each of which are assigned to the assignee of the present invention and hereby incorporated by reference. According to the '337 and '498 patents, the tickets are stored in a fanfold form and the individual tickets are burst, rather than cut, apart prior to dispensing. The separation mechanism of the '337 and '498 patents comprises a bursting wheel which separates the leading ticket from the next following ticket along the line of weakness therebetween instead of cutting the two tickets apart. The burster wheel inherently reduces the risk of producing only half a ticket. The burster wheel of the '337 patent is in the form of a circular burster blade which has a dull rounded edge that does not cut the stream of tickets but rather exerts pressure against the top of the stream of tickets to deflect the tickets and separate them along the line of weakness separating the tickets. The burster wheel in the '498 has a flattened peripheral surface to increase the effective range of the burster wheel. The burster wheel in each patent is moved back and forth across the connected tickets.

For the burster wheel to effectively burst the leading ticket from the stream of tickets along the line of weakness, it must be sufficiently aligned with the lines of weakness and in close proximity thereto. However, many factors detrimentally impact the ability to consistently align the path of the burster wheel with the lines of weakness or perforations. For example, the manufacturing tolerances of the tickets vary greatly. The length of individual tickets with respect to other tickets in the same fanfold stream varies a relatively large amount and may be on the order of 1/16 inch or so. As a result, even though the burster wheel may be aligned with the majority of the lines of weakness in a given fanfold stream, due to the variations in the lengths of the tickets, it is commonly misaligned with other lines of weakness and thereby may provide an ineffective separation or fail to separate the tickets at all.

Similarly, the perforations or lines of weakness between the individual tickets are not uniformly formed such that a greater force may be required from the bursting wheel to separate one line of weakness than another line of weakness in the same fanfold stream. Tickets are manufactured with varying degrees of perforation quality. Some have tough perforations while some perforations are easily separated. It is widely recognized that perforation quality varies greatly due to a number of variables including, the ticket printing company, ticket stock, ticket coatings and the like. Aside from these variables, perforation quality can still vary within the same game with the same ticket press run. The consistency of ticket perforations vary not only from company to company but also from game to game provided by the same manufacturer.

Moreover, the added force required to burst a poorly formed line of weakness requires more precise alignment between the burster wheel and the line of weakness to effectuate a separation. Therefore, misalignment between the line of weakness and the path of the burster wheel is even more critical when the perforation is poorly formed.

With the systems disclosed in the '337 and '498 patents, the tickets are transported through the burster portion of the lottery ticket dispenser by feed rollers upstream from the burster and exit or discharge rollers downstream from the burster. The feed rollers are rotationally driven by a first motor and the exit rollers are rotationally driven by a second, different motor. As a result of this arrangement, a significant amount of labor and time is required to calibrate and synchronize the roller motors and the precise position of the rollers in the dispenser to consistently and reliably position the line of weakness between adjacent tickets in the path of the burster wheel. Additionally, the vagaries and differences between individual motors, even those of the same model and manufacturer, often require specific adjustments for proper dispenser operation. Moreover, with hundreds or thousands of individual lottery ticket vending machines in each state or lottery region, the labor requirements for the proper setup of the machines is highly demanding and burdensome. It is important to have a reliable separation mechanism for each individual dispensing unit which is not compromised by these variables.

### SUMMARY OF THE INVENTION

These and other shortcomings of prior lottery ticket dispensers have been overcome by this invention. In one embodiment, a lottery ticket dispenser according to this invention includes a transport mechanism for feeding the lottery tickets along a dispensing path. Each of the lottery tickets is joined to an adjacent lottery ticket by a line of weakness such as perforations or the like. The dispenser includes a burster wheel that translates across the dispensing path near the line of weakness to separate the adjacent lottery tickets from one another. A pair of feed rollers, at least one of which is rotationally driven contact the lottery ticket at a location along the dispensing path upstream of the burster wheel to advance and feed the lottery tickets towards the burster wheel. Additionally, a pair of discharge rollers, at least one of which is rotationally driven, are located along the dispensing path downstream of the burster wheel to discharge the lottery tickets which have been separated by the bursting wheel. Importantly, the rotationally driven feed and discharge rollers are both operatively coupled to a drive mechanism such as a motor or the like to cooperate in positioning and holding the lottery tickets while the burster wheel separates them.

In one embodiment, the drive mechanism includes a motor with a drive shaft having a drive gear mounted thereon. The drive gear meshes with a feed gear coupled to the feed roller and a discharge gear coupled to the discharge roller. Since both the discharge and feed rollers are rotationally driven by the same motor, the synchronization and calibration steps required by previous lottery ticket dispensers are advantageously avoided. Further, in one embodiment the discharge gear is smaller than the feed gear which produces a higher rotational velocity to the discharge roller than the feed roller so that the tickets after separation are discharged quickly and efficiently.

This invention may also include first and second platens along the dispensing path which are located upstream and downstream, respectively, from the feed roller. The platens are configured and positioned to guide and support the tickets along the dispensing path and for separation by the burster wheel.

Another feature of this invention in one embodiment is the mechanism by which the burster wheel translates across the dispensing path to separate the tickets. The motorized cable and pulley system of prior lottery ticket dispensing systems for translating the burster wheel back and forth across the tickets is in one embodiment replaced with a toothed rack and gear drive mechanism. This mechanism is less susceptible to breakage and provides a more efficient transmission of power to translate the burster wheel across the path of tickets.

As a result of the various features of the invention, an improved lottery ticket dispenser provides a more reliable and consistent separation of lottery tickets while requiring fewer repairs and less time and labor for calibration and setup of the individual units

### BRIEF DESCRIPTION OF THE DRAWINGS

The objective and features of the invention are readily apparent from the following detailed description taken in conjunction with the accompanying drawings in which:

FIG. 1 is a perspective view of one embodiment of the transport mechanism and burster assembly for feeding a stream of tickets and separating the adjacent tickets along a line of weakness within a dispensing unit according to this invention;

FIG. 2 is a side view partially broken away showing the transport mechanism according to one embodiment of this invention; and

FIG. 3 is a schematic side view of a dispensing path for the lottery tickets showing the feed and discharge rollers relative to the burster wheel.

### DETAILED DESCRIPTION OF THE INVENTION

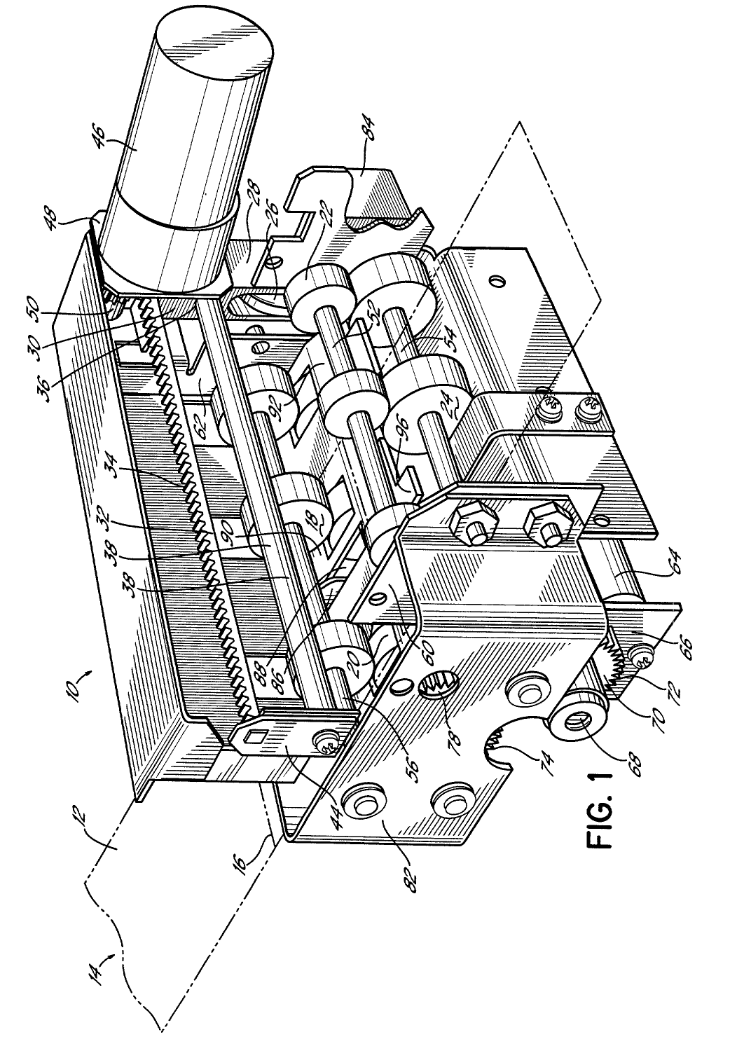

A transport mechanism and burster assembly 10 is shown in FIG. 1 for a lottery ticket dispenser (not shown). A typical lottery ticket dispenser is shown in U.S. Pat. Nos. 4,982,337 and 5,836,498, the disclosures of which are hereby incorporated by reference. A plurality of individual tickets 12 are connected in a fanfold strip or stream 14. Individual tickets 12 are joined to an adjacent ticket by a line of weakness 16 which typically comprises perforations. The tickets 12 are provided typically by the state authority in a fanfold stack which is compact and easily transportable and typically include as many as 1,500 tickets in each stack. A stack of fanfold tickets 12 are contained in a storage compartment (not shown) in the lottery ticket dispenser. Each ticket 12 is connected to an adjacent ticket 12 along the line of weakness 16 and it will be understood that each successive following ticket 12 is joined to an adjacent ticket by a similar line of weakness 16.

The fanfold stream 14 of tickets 12 is fed along a dispensing path from the storage compartment toward an outlet (not shown). The stream 14 is transported along the dispensing path by the transport mechanism 10 including opposed upper feed rollers 18, three of which are shown in FIG. 1, and lower feed rollers 20 and opposed upper discharge rollers 22 and lower discharge rollers 24.

A generally circular burster wheel 26 is mounted for rotation between spaced, downwardly extending flanges 28 of a burster block 30. The burster wheel 26 is mounted for rotation on the burster block 30 on an axle (not shown) extending between the spaced flanges 28. The burster block 30 includes a bore hole 36 through which extends a burster bar 38. The burster block 30 is mounted for a translation along the burster bar 38 between opposed side brackets 44 of the transport mechanism 10.

A rack 32 having a plurality of upwardly directed teeth 34 on an upper surface thereof is fixedly mounted between the side brackets 44. A motor 46 is mounted on a plate 48 coupled to the burster block 30 and a rotationally driven shaft (not shown) projects from the motor 46. A spur gear 50 or the like is mounted on the shaft and engages the teeth 34 on the rack 32. As the motor rotates the shaft and gear 50 in a first direction, the gear engages the teeth 34 to move the motor, 46 and burster block 30 in a first direction so the burster wheel 26 intersects the fanfold stream 14 of tickets 12. Similarly, reverse rotation of the shaft and gear 50 moves the burster block 30 and wheel 26 in a second direction opposite the first direction to there again intersect the fanfold stream 14.

When the burster block 30 and burster wheel 26 are moved from the rest position illustrated in FIG. 1 toward interception with the dispensing path of the stream 14 of tickets 12 through the action of the motor 46, the burster wheel 26 will come into contact with the stream 14 of tickets 12 at the side thereof initially then across the stream 14 of tickets 12 to burst the adjacent tickets 12 apart along the line of weakness 16. The burster block 30 is moved from right to left as shown in FIG. 1 to burst the leading ticket 12, then left to right to burst the next leading ticket 12, and so on.

The burster block 30 and wheel 26 translate along the bar 38 to intersect the dispensing path of the stream 14 of tickets 12 perpendicularly. As a result, the path of the burster wheel 26 on the tickets 12 is generally parallel to the line of weakness 16 separating the adjacent tickets 12.

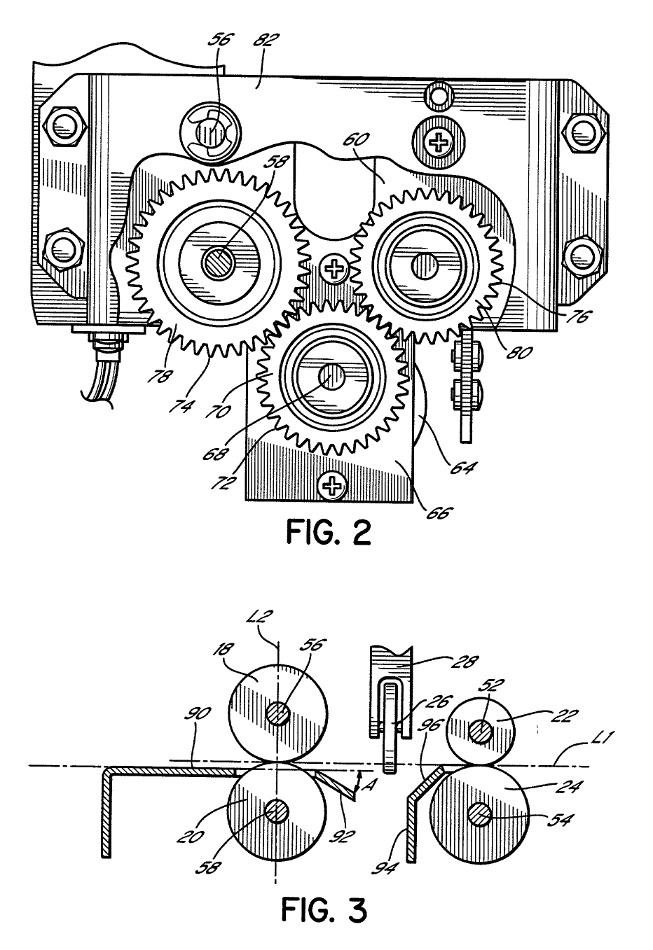

The upper discharge rollers 22 are journaled on a common upper discharge shaft 52 and the lower discharge rollers 24 are journaled similarly on a lower exit shaft 54. Likewise, the upper feed rollers 18 are journaled on a common upper feed shaft 56 and the lower feed rollers 20 are journaled on a common lower feed shaft 58 (FIGS. 2 and 3). The shafts 52, 54, 56, 58 extend between side mounting plates 60, 62 of the transport mechanism and burster assembly 10. Preferably the rollers 18, 20, 22, 24 are rubber or another polymeric material for high friction gripping and contact. The rollers 18, 20, 22, 24 may be integrally formed with the shafts 52, 54, 56 and 58 or simply mounted thereon for rotation with the respective shaft.

In one embodiment, the upper feed rollers 18 and upper discharge rollers 22 are rotationally driven by common drive mechanism or motor 64 as shown in FIGS. 1 and 2. The motor 64 is mounted to a downwardly extending drive plate portion 66 of the plate 60. A rotationally driven drive shaft 68 extends from the motor 64 through the drive plate 66 and is coupled to a drive gear 70. Drive gear has teeth 72 which mesh with the teeth 74, 76 on both a feed gear 78 and a discharge gear 80 as shown in FIG. 2. The feed gear 78 is mounted on the upper feed shaft 56 and the discharge gear 80 is mounted on the upper discharge shaft 52. The position of the shafts 56, 52 is fixed relative to one another within the dispenser by the side mounting plates 60. Similarly, the rotational velocity of the discharge and feed rollers 18, 22 is synchronized and calibrated with respect to each other because they are each rotationally driven by the same drive mechanism or motor 64 through the gear arrangement as previously described. As such, the calibration and synchronization of the discharge and feed rollers 18, 22 which previously were separately driven by individual motors or the like is not necessary with this system.

In one embodiment of this invention, the discharge gear 80 is smaller than the feed gear 78 each of which mesh with the drive gear 70. As a result, the rotational velocity of the discharge gear 80 and upper discharge shaft 52 and discharge rollers 22 is greater than the rotational velocity of the feed gear 78, feed shaft 56 and feed rollers 18. As such, after the tickets 12 are separated by the burster wheel 26 they are quickly and efficiently discharged from the system 10 by the discharge rollers 22 so that subsequent tickets 12 may be fed by the feed rollers 18 along the dispensing path toward the discharge rollers 22 for perforation separation as required. The gears 70, 74, 80 are protected by a cover plate 82 as shown in FIG. 1 and partially broken away in FIG. 2.

In operation, the user/operator would input to a controller 84 the length of the specific tickets 12 which have been loaded into the dispenser system 10. Typically, the lottery tickets 12 or the like are manufactured in 2 inch, 3 inch or 4 inch lengths. With this information, the controller 84 then regulates the operation of the motor 64 and to likewise the rotationally driven feed and discharge rollers 18, 22 to advance the tickets 12 the appropriate distance depending upon the number of tickets 12 to be dispensed to locate the line of weakness 16 between the adjacent tickets 12 in line with the path of the burster wheel 26 for separation. The direct drive of the feed and discharge rollers 18, 22 from a single drive mechanism 64 significantly increases the reliability and operational performance of the dispenser system 10 while reducing and minimizing the required calibration, setup and adjustment of the system 10 for individual ticket parameters and similar characteristics.

A sensor 86 is preferably located immediately upstream from the feed rollers 18 to detect the leading edge of the leading ticket 12 of a stream of tickets being input into the system 10. In one embodiment, the sensor 86 may simply be a mechanical gate or toggle which deflects downwardly upon pressure from the ticket 12. Alternatively, the sensor 84 may be optical or another such device known to those skilled in the art. The sensor 86 as shown in FIG. 1 is mounted in an access opening 88 in a platen 90 located immediately upstream from the feed rollers 18 as shown in FIG. 3. The first platen 90 has an upper surface upon which the tickets are supported prior to entering the feed rollers 18. Preferably, the upper surface of the platen 90 is positioned below, on the order of 1/16th of an inch or less, a reference line L1 which is tangential to both the feed roller 18 and idler feed roller 20 and perpendicular to a line L2 passing through the axes of rotations of the feed and idler feed rollers 18, 20 as shown in FIG. 3. Positioning the platen 90 and thereby the incoming tickets 12 in such a manner helps prevent ticket jams and malfunctions in the ticket feeding process and likewise improves the burster wheel 26 reliability for separating the adjacent tickets 12. In one embodiment, the reference line L1 is also a common tangent line between the discharge rollers 22, 24 and shown in FIG. 3.

A second platen 92 located downstream from the feed roller 18 and upstream from the path of the burster wheel 26 is also included in one embodiment of this invention as shown in FIG. 3. This platen 92 preferably slopes downwardly at an angle A of approximately 20°-45°. The platen 92 supports the tickets being held between the feed rollers 18, 20 and the discharge rollers 22, 24 as the burster wheel 26 transverses across the dispensing path to separate the line of weakness 16 between the adjacent tickets 12. The platen 92 also provides a better bursting reliability and quality for the system 10 particularly for tickets 12 with imperfectly formed perforations or lines of weakness 16 or the like. It will be appreciated that as the burster wheel 26 contacts the tickets 12 between the feed and discharge rollers 18, 22, the tickets 12 will deflect downwardly during the bursting process and are thereby supported by the downwardly sloped platen 92.

Additionally, a guide 94 as shown in FIG. 3 is positioned to immediately upstream from the discharge rollers 22 to direct the leading edge of the ticket 12 which has been separated from the adjacent ticket 12 by the burster wheel 26 into the discharge rollers 22, 24. Once again, the guide 94 preferably has a sloped surface 96 to accept and direct the tickets 12 into and in between the discharge rollers 22, 24.

From the above disclosure of the general principles of the present invention and the preceding detailed description of a preferred embodiment, those skilled in the art will readily comprehend the various modifications to which this invention is susceptible. Therefore, I desire to be limited only by the scope of the following claims and equivalents thereof.

I claim:

1. A system for separating individual, planar articles joined together along a line of weakness comprising:
a transport mechanism for feeding the articles along a dispensing path;
a separator located along the dispensing path by which adjacent articles are separated from one another;
at least one rotationally driven feed roller contacting the articles at a location along the dispensing path upstream of the separator to advance the articles toward the separator;
at least one rotationally driven discharge roller contacting the articles at a location along the dispensing path downstream of the separator to discharge the articles from the separator; and
a drive mechanism operatively coupled to both the feed and discharge rollers, the discharge and feed rollers each being rotationally driven by the drive mechanism and cooperating to hold the articles while the separator separates the pair of adjacent articles.

2. The system of claim 1 wherein the drive mechanism comprises a motor with a drive shaft coupled to a drive gear, the drive gear meshing with a feed gear coupled to the feed roller and a discharge gear coupled to the discharge roller.

3. The system of claim 2 wherein the discharge gear is smaller than the feed gear to produce a higher rotational velocity to the discharge roller than to the feed roller.

4. The system of claim 1 wherein the separator is a burster wheel that translates across the dispensing path proximate the line of weakness between adjacent articles to thereby separate the adjacent articles from one another.

5. The system of claim 1 wherein the discharge roller advances one of the adjacent articles toward an outlet after it is separated along the line of weakness by the separator.

6. The system of claim 1 further comprising:
at least one idler feed roller contacting the articles at a location along the dispensing path upstream from the separator and cooperating with the feed roller to position and advance the articles passing between the idler feed roller and the feed roller to the separator; and
at least one idler discharge roller contacting the articles at a location along the dispensing path downstream from the separator and cooperating with the discharge roller to accept and advance the articles from the separator, the articles passing between the idler discharge roller and the discharge roller.

7. The system of claim 6 further comprising:
a first platen upstream from the feed roller, the first platen having a surface upon which the articles are supported prior to entering the feed and idler feed rollers, the surface being positioned below a reference line which is tangential to both the feed roller and the idler feed roller and perpendicular to a line passing through the axes of rotation of the feed and idler feed rollers.

8. The system of claim 4 further comprising:
a second platen downstream from the feed roller and upstream from the burster wheel to support the articles while the burster wheel separates the adjacent articles from one another.

9. The system of claim 8 wherein the second platen slopes downwardly to support the articles as the burster wheel depresses them during the separation of the adjacent articles.

10. The system of claim 1 further comprising:
a guide upstream from the discharge roller and downstream from the separator to guide a leading edge of the articles toward the discharge roller.

11. The system of claim 4 wherein the separator further comprises:
a rotationally driven spur gear;
a block having the spur gear mounted thereon;
a rack with a plurality of teeth meshing with the spur gear, the burster wheel being mounted to the block so that rotation of the spur gear translates the burster wheel across the dispensing path and into contact with the articles to thereby separate the adjacent articles along the line of weakness.

12. A lottery ticket dispenser comprising:
a transport mechanism for feeding the lottery tickets along a dispensing path, each of the lottery tickets being joined to an adjacent lottery ticket by a line of weakness;
a separator located along the dispensing path by which adjacent lottery tickets are separated from one another;
at least one rotationally driven feed roller contacting the lottery tickets at a location along the dispensing path upstream of the separator to advance the lottery tickets toward the separator;
at least one rotationally driven discharge roller contacting the lottery tickets at a location along the dispensing path downstream of the separator to discharge the lottery tickets from the separator; and
a drive mechanism operatively coupled to both the feed and discharge rollers, the discharge and feed rollers each being rotationally driven by the drive mechanism and cooperating to hold the lottery tickets while the separator separates the pair of adjacent lottery tickets.

13. The lottery ticket dispenser of claim 12 wherein the drive mechanism comprises a motor with a drive shaft coupled to a drive gear, the drive gear meshing with a feed gear coupled to the feed roller and a discharge gear coupled to the discharge roller.

14. The lottery ticket dispenser of claim 13 wherein the discharge gear is smaller than the feed gear to produce a higher rotational velocity to the discharge roller than to the feed roller.

15. The lottery ticket dispenser of claim 12 wherein the separator is a burster wheel that translates across the dispensing path proximate the line of weakness between adjacent lottery tickets to thereby separate the adjacent lottery tickets from one another.

16. The lottery ticket dispenser of claim 13 wherein the discharge roller advances one of the adjacent lottery tickets toward an outlet after it is separated along the line of weakness by the separator.

17. The lottery ticket dispenser of claim 12 further comprising:
at least one idler feed roller contacting the lottery tickets at a location along the dispensing path upstream from the separator and cooperating with the feed roller to position and advance the lottery tickets passing between the idler feed roller and the feed roller to the separator; and
at least one idler discharge roller contacting the lottery tickets at a location along the dispensing path downstream from the separator and cooperating with the discharge roller to accept and advance the lottery tickets from the separator, the lottery tickets passing between the idler discharge roller and the discharge roller.

18. The lottery ticket dispenser of claim 17 further comprising:
a first platen upstream from the feed roller, the first platen having a surface upon which the lottery tickets are supported prior to entering the feed and idler feed rollers, the surface being positioned below a reference line which is tangential to both the feed roller and the idler feed roller and perpendicular to a line passing through the axes of rotation of the feed and idler feed rollers.

19. The lottery ticket dispenser of claim 15 further comprising:
a second platen downstream from the feed roller and upstream from the burster wheel to support the lottery tickets while the burster wheel separates the adjacent lottery tickets from one another.

20. The lottery ticket dispenser of claim 19 wherein the second platen slopes downwardly to support the lottery tickets as the burster wheel depresses them during the separation of the adjacent lottery tickets.

21. The lottery ticket dispenser of claim 12 further comprising:
a guide upstream from the discharge roller and downstream from the separator to guide a leading edge of the lottery tickets toward the discharge roller.

22. The lottery ticket dispenser of claim 15 wherein the separator further comprises:
a rotationally driven spur gear;
a block having the spur gear mounted thereon;
a rack with a plurality of teeth meshing with the spur gear, the burster wheel being mounted to the block so that rotation of the spur gear translates the burster wheel across the dispensing path and into contact with the lottery tickets to thereby separate the adjacent lottery tickets along the line of weakness.

23. A lottery ticket dispenser comprising:
a transport mechanism for feeding the lottery tickets along a dispensing path, each of the lottery tickets being joined to an adjacent lottery ticket by a line of weakness;
a burster wheel that translates across the dispensing path proximate the line of weakness between adjacent lottery tickets to thereby separate the adjacent lottery tickets from one another;
at least one rotationally driven feed roller contacting the lottery tickets at a location along the dispensing path upstream of the burster wheel to advance the lottery tickets toward the burster wheel;
at least one idler feed roller contacting the lottery tickets at a location along the dispensing path upstream from the burster wheel and cooperating with the feed roller to position and advance the lottery tickets passing between the idler feed roller and the feed roller to the burster wheel; and
at least one rotationally driven discharge roller contacting the lottery tickets at a location along the dispensing path downstream of the burster wheel to discharge the lottery tickets from the burster wheel;
at least one idler discharge roller contacting the lottery tickets at a location along the dispensing path downstream from the burster wheel and cooperating with the discharge roller to accept and advance the lottery tickets from the burster wheel, the lottery tickets passing between the idler discharge roller and the discharge roller; and
a drive mechanism operatively coupled to both the feed and discharge rollers, the discharge and feed rollers each being rotationally driven by the drive mechanism and cooperating to hold the lottery tickets while the burster wheel separates the pair of adjacent lottery tickets, wherein the drive mechanism comprises a motor with a drive shaft coupled to a drive gear, the drive gear meshing with a feed gear coupled to the feed roller and a discharge gear coupled to the discharge roller;
wherein the discharge gear is smaller than the feed gear to produce a higher rotational velocity to the discharge roller relative to the feed roller.

24. The lottery ticket dispenser of claim 23 further comprising:
a first platen upstream from the feed roller, the first platen having a surface upon which the lottery tickets are supported prior to entering the feed and idler feed rollers, the surface being positioned below a reference line which is tangential to both the feed roller and the idler feed roller and perpendicular to a line passing through the axes of rotation of the feed and idler feed rollers.

25. The lottery ticket dispenser of claim 24 further comprising:
a second platen downstream from the feed roller and upstream from the burster wheel to support the lottery tickets while the burster wheel separates the adjacent lottery tickets from one another, wherein the second platen slopes downwardly to support the lottery tickets as the burster wheel depresses them during the separation of the adjacent lottery tickets.

26. The lottery ticket dispenser of claim 25 further comprising:
a guide upstream from the discharge roller and downstream from the burster wheel to guide a leading edge of the lottery tickets toward the discharge roller.

27. The lottery ticket dispenser of claim 26 wherein the burster wheel further comprises:
a rotationally driven spur gear;
a block having the spur gear mounted thereon;
a rack with a plurality of teeth meshing with the spur gear, the burster wheel being mounted to the block so that rotation of the spur gear translates the burster wheel across the dispensing path and into contact with the lottery tickets to thereby separate the adjacent lottery tickets along the line of weakness.

28. A method of dispensing lottery tickets comprising the steps of:
passing a plurality of lottery tickets connected in a fanfold stream along a dispensing path, a pair of adjacent the tickets being separable from each other along a line of weakness therebetween;
feeding the lottery tickets toward a feed roller along the dispensing path;
separating adjacent tickets from one another along the line of weakness with a separator located downstream from the feed roller;
discharging the lottery tickets from the separator with a discharge roller located downstream from the separator; and
rotationally driving both the feed and discharge rollers from a single drive mechanism.

29. The method of claim 28 further comprising:
driving the discharge roller at a higher rotationally velocity than the feed roller.

30. The method of claim 28 wherein the separating further comprises:
bursting the line of weakness with a burster wheel contacting the stream of tickets proximate the line of weakness.
